(19) United States
(12) Patent Application Publication
(10) Pub. No.: US 2025/0350841 A1
(43) Pub. Date: Nov. 13, 2025

(54) SUBJECT TRACKING APPARATUS AND CONTROL METHOD THEREOF, IMAGE CAPTURING SYSTEM, AND STORAGE MEDIUM

(71) Applicant: CANON KABUSHIKI KAISHA, Tokyo (JP)

(72) Inventor: NAOKI MARUYAMA, Tokyo (JP)

(21) Appl. No.: 19/174,376

(22) Filed: Apr. 9, 2025

(30) Foreign Application Priority Data
May 8, 2024 (JP) 2024-076073

(51) Int. Cl. H04N 23/695; H04N 23/69

(52) U.S. Cl. CPC H04N 23/695; H04N 23/69

(57) ABSTRACT

An image capturing system configured to perform tracking control of a subject according to operation instructions, wherein an image capturing section provided with a lens group 201 and an image capturing element 205 performs image capturing of a subject that is a tracking target. An optical control unit 211 performs control of angle of view adjustment by driving a zoom lens. A PT control unit 212 performs drive control in a panning direction and a tilting direction. The image capturing system acquires distance information indicating distance from the image capturing unit to the subject and performs setting or changing of an image capturing direction or angle of view. Speed of control or speed range is changed according to distance of the subject. The image capturing system performs control so as to make speed of control smaller as distance of the subject becomes larger.

### BACKGROUND OF THE INVENTION

### Field of the Invention

The present invention relates to a subject tracking apparatus and a control method thereof, an image capturing system, and a storage medium.

### Description of the Related Art

In image capturing systems using network cameras and the like, a user can perform setting instructions of image capturing direction and image capturing range via remote operation, and can perform image capturing of a desired subject. By remote operation of an image capturing apparatus, image capturing is possible even when a user is not at a site, and labor savings can be realized by performing automatic image capturing according to a program prepared in advance.

Hereinafter, with respect to control of image capturing direction and image capturing range of the image capturing apparatus, pan or panning is denoted as “P”, tilt or tilting is denoted as “T”, zoom or zooming is denoted as “Z”, and these are collectively denoted as “PTZ”.

However, compared to operations of the image capturing apparatus performed directly by an operator at a site, there is a possibility that operations become coarse in automatic image capturing. Accordingly, methods for enabling more detailed remote operation of the image capturing apparatus have been proposed.

In Japanese Patent Laid-Open No. H07-107373, technology for resolving unnaturalness of screen changes accompanying PT operations in a zoom-in or zoom-out state is disclosed. A control unit performs variable control of operation speed in P drive units and T drive units according to zoom state. Control is performed so that PT rotation speed is made slower when displaying a subject enlarged on a screen, and PT rotation speed is made faster when displaying a subject reduced on a screen.

In addition, in Japanese Patent Laid-Open No. 2021-180379, technology that supports continuous user observation so as to prevent subject frame-out is disclosed. The image capturing apparatus is configured to detect a position of a subject that serves as a trimming target from images, and is configured to generate a trimming image configured to notify a user that the subject is about to deviate from an image capturing range in a case in which the position of the subject is included in a predetermined region.

In conventional technology, in a case in which control of PT operations has been performed without considering a state of a moving subject that is an image capturing target, it is difficult to perform detailed tracking control with respect to the moving subject. In the technology disclosed in Japanese Patent Laid-Open No. H07-107373, because PT rotation speed is determined regardless of distance of the subject, there is no distinction as to whether or not the subject being tracked is a subject at a close distance or a subject at a far distance. Accordingly, more detailed control of subject tracking operations cannot be performed.

In addition, the technology disclosed in Japanese Patent Laid-Open No. 2021-180379 generates trimming images of subjects within two-dimensional images, and processing is not performed according to distance information or depth information of subjects in a depth direction within images. In order to perform sufficient tracking control, information in the depth direction is needed in addition to movement amounts of subjects in planar coordinates.

### SUMMARY OF THE INVENTION

One aspect of the present invention is a subject tracking apparatus configured to perform subject tracking by capturing images of a subject using an image capturing unit, the subject tracking apparatus comprising an acquisition unit configured to acquire distance information of the subject, and a control unit configured to change, by controlling the image capturing unit, an image capturing direction or an image capturing range, and a speed of control. The control unit is configured to set or change the speed of control corresponding to the acquired distance information.

Further features of the present invention will become apparent from the following description of embodiments with reference to the attached drawings.

### BRIEF DESCRIPTION OF THE DRAWINGS

FIG. 1 is a schematic diagram explaining differences in methods of capturing a subject according to subject distance.

FIG. 2 is a diagram showing a configuration example of an image capturing system according to an embodiment.

FIG. 3 is a schematic diagram explaining a method of setting camera speed according to subject distance.

FIG. 4 is a flowchart explaining processing according to a first embodiment.

FIG. 5 is a diagram explaining PT speed control characteristics based on subject distance.

FIG. 6 is a diagram explaining PT speed control characteristics based on subject distance and zoom position.

FIG. 7 is a flowchart explaining a processing example according to a second embodiment.

FIG. 8 is a diagram explaining a PT speed range according to subject distance or zoom position.

FIG. 9 is a flowchart explaining another processing example according to the Second Embodiment.

FIG. 10 is a flowchart explaining yet another processing example according to the Second Embodiment.

FIG. 11 is a diagram explaining a PT speed range based on subject distance and zoom position.

FIG. 12 is a flowchart explaining processing according to a third embodiment.

FIG. 13 is a diagram explaining an example of a positional relationship between an image capturing angle of view and a moving subject.

FIG. 14 is a flowchart explaining processing according to a fourth embodiment.

FIG. 15 is a diagram explaining an example of a positional relationship between a reference position within an image capturing angle of view and a moving subject.

FIG. 16 is a flowchart explaining processing according to a fifth embodiment.

FIG. 17 is a flowchart explaining processing according to a sixth embodiment.

FIG. 18 is a diagram explaining speed control from an acceleration state to a constant speed state.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

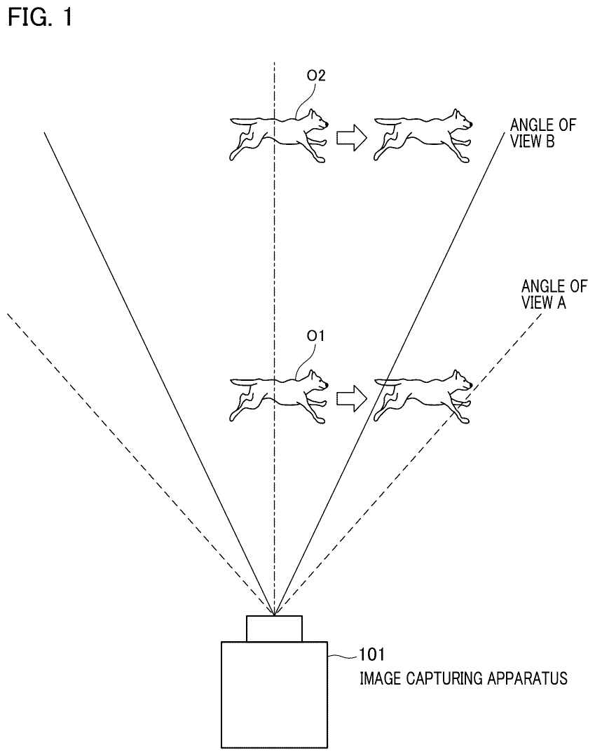

For example, an image capturing system according to the embodiments performs subject tracking control via remote operation. Before explaining the configuration of the image capturing system, with reference to FIG. 1, an explanation is provided with respect to differences in capturing of the subject according to the distance of the subject.

In the present disclosure, “camera speed” refers to any of the following speeds, for example:
a speed related to posture control that changes the image capturing direction of the image capturing apparatus (pan speed, tilt speed, or the like);
a speed related to lens operation control that changes the image capturing angle of view of the image capturing apparatus (zoom speed or the like); or
a control speed related to processing that trims an image within the image capturing angle of view (trimming processing) (speed of changing electronic zoom or clipping position or the like).

FIG. 1 is a schematic diagram showing positional relationships between a subject O1 and a subject O2 at different distances and an image capturing apparatus 101, wherein the position of the image capturing apparatus 101 serves as a reference. The first subject O1 and the second subject O2 are tracking targets (tracking subjects) of the image capturing apparatus 101.

The first subject O1 represents a moving subject at a close distance relative to the image capturing apparatus 101, and image capturing is performed using an angle of view A. The second subject O2 represents a moving subject at a far distance relative to the image capturing apparatus 101, and image capturing is performed using an angle of view B. The angle of view B is narrower compared to the angle of view A. In addition, the first subject O1 and the second subject O2 are moving in the same direction at the same movement speed.

In FIG. 1, even for a subject O1 and a subject O2 that move in the same manner, the following possibilities may exist due to differences in distances from the image capturing apparatus:
a case in which the camera cannot follow the subject because the camera speed is below a predetermined tracking speed threshold.
a case in which more detailed camera operations cannot be performed because the camera speed is exceeds a predetermined control precision threshold.

Therefore, the present disclosure explains a configuration and method for performing more detailed tracking control of a moving subject.

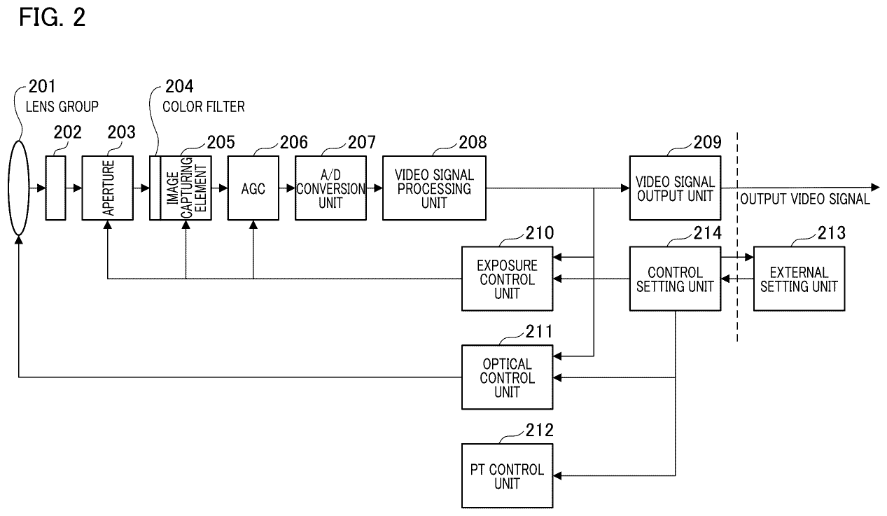

FIG. 2 is a diagram showing an example of an image capturing system according to the present embodiment. The image capturing system is capable of control of image capturing direction and image capturing range, and performs tracking control of a subject according to operation instructions.

The image capturing unit that configures the image capturing system is capable of performing PTZ control using known methods. PT driving is driving in the P direction and T direction, and P values and T values correspond to posture control values related to the image capturing direction. In addition, Z control is angle of view control, and Z value corresponds to angle of view control values.

In FIG. 2, a lens group 201 that configures the image capturing unit configures an optical system that converges light incident from a subject. Hereinafter, the subject side is defined as the front side. The lens group 201 includes a focus lens for performing focusing with respect to the subject and a zoom lens for adjusting the angle of view.

An optical filter 202 and an aperture 203 are disposed on the back side of the lens group 201. Light entering inside the camera through the lens group 201 passes through the optical filter 202. The optical filter 202 is an infrared cut filter (IRCF) and the like. The aperture 203 adjusts an amount of light incident on an image capturing element 205. The adjusted light passes through the color filter 204 and is received by the image capturing element 205.

The color filter 204 is arranged in a predetermined order for each pixel of a light-receiving surface of the image capturing element 205. The image capturing element 205 is a CCD (Charge Coupled Device) image sensor or a CMOS (Complementary Metal Oxide Semiconductor) image sensor and the like. The image capturing element 205 outputs an analog signal by performing photoelectric conversion and acquiring captured image information of the subject.

An automatic gain control unit (denoted as AGC) 206 performs automatic gain control with respect to an output signal from the image capturing element 205. The analog image capturing signal that has undergone luminance adjustment by the AGC 206 is input to an A/D conversion unit 207. The A/D conversion unit 207 converts the analog image capturing signal into a digital image capturing signal.

A video signal processing unit 208 performs predetermined processing on the digital imaging signal from the A/D conversion unit 207 and outputs luminance signals and color signals for each pixel. The video signal processing unit 208 performs processing to generate video for output and processing to generate parameters for performing camera control. Examples of the parameters are shown below.
Parameters for aperture control.
Parameters for AF evaluation (frequency component values and the like of image capturing signals for performing automatic focusing).
Parameters for white balance control for adjusting color tone.

The video signal processing unit 208 outputs generated video signals to a video signal output unit 209. The video signal output unit 209 outputs video signals to an external apparatus (a display apparatus, a recording apparatus, a printing apparatus, and the like).

An exposure control unit 210 acquires luminance information from a signal output by the video signal processing unit 208 and calculates luminance within the image capturing screen. The exposure control unit 210 controls the aperture 203 and the AGC 206 so as to adjust captured images to desired brightness. In addition, accumulation time of the image capturing element 205 is adjusted by adjustment of shutter speed, and brightness of the captured image can be adjusted.

An optical control unit 211 controls the lens group 201. For example, in automatic focusing, the optical control unit 211 calculates AF evaluation values by extracting high-frequency components from video signals generated by the video signal processing unit 208. The optical control unit 211 performs drive control of the focus lens so that the AF evaluation value become maximum. In addition, the optical control unit 211 performs control of angle of view adjustment by driving of the zoom lens.

A PT control unit 212 controls the image capturing direction by performing drive control of the P direction and T direction related to the image capturing unit. Because the drive mechanism unit related to PT control is known, a detailed explanation thereof is omitted.

An external setting unit 213 serves as a unit configured to perform operations of the image capturing apparatus and performs various settings. For example, the external setting unit 213 is a personal computer (PC). The external setting unit 213 can perform settings of general camera operations such as focusing, image brightness, and specification of zoom magnification, and settings for tracking a desired subject. The external setting unit 213 outputs desired control commands to a control setting unit 214.

The control setting unit 214 performs, with respect to the exposure control unit 210, the optical control unit 211, and the PT control unit 212, control settings according to control commands for the image capturing apparatus from the external setting unit 213. Settings of exposure control, lens control, PT speed control, and the like are performed. In addition, the control setting unit 214 is capable of performing correction processing associated with setting operation content according to control commands from the external setting unit 213.

### First Embodiment

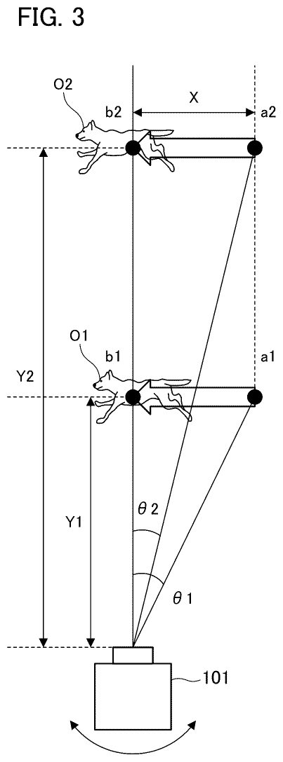

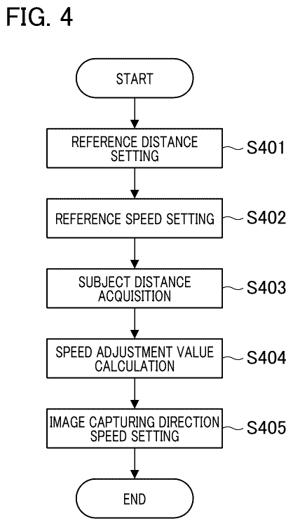

With reference to FIG. 3 and FIG. 4, an explanation is provided with respect to camera control according to the present embodiment. FIG. 3 is a schematic diagram for explaining a setting method of camera speed according to distance to a subject. In FIG. 3, wherein the position of the image capturing apparatus 101 serves as a reference, a depth direction of the subject is defined as the Y-axis direction, and a left-right direction orthogonal to the Y-axis direction is defined as the X-axis direction.

A distance from the image capturing apparatus 101 to a first subject O1 is denoted as Y1, and a distance from the image capturing apparatus 101 to a second subject O2 is denoted as Y2. “Y1<Y2” is established. The first subject O1 moves from point a1 to point b1 in the X-axis direction.

The second subject O2 moves from a point a2 to a point b2 in the X-axis direction. In tracking control of the subject O1 or O2, the PT control unit 212 performs drive control in the P direction. An angle θ1 corresponds to a P value in tracking control of the subject O1, and an angle θ2 corresponds to a P value in tracking control of the subject O2. A value of the angle θ1 is greater than a value of the angle θ2 (θ1>θ2).

In FIG. 3, a case is assumed in which the subject O1 and the subject O2 move in the X-axis direction at the same movement speed. Even at the same movement speed, a drive control amount in the P direction of the image capturing apparatus differs according to a distance from the image capturing apparatus to the subject.

In a case in which the first subject O1 moves from point a1 to point b1 at the distance Y1, an angle in the P direction is set to θ1, and image capturing is possible while capturing the subject O1 in the center. In contrast, in a case in which the second subject O2 moves from point a2 to point b2 at the distance Y2, the angle in the P direction is set to θ2, and image capturing is possible while capturing the subject O2 in the center.

Processing according to the present embodiment will be explained with reference to FIG. 4. The image capturing apparatus performs setting processing of an amount of drive control in the P direction according to a distance to a subject. The processing described hereinafter is realized by a CPU (Central Processing Unit) that is provided in the image capturing apparatus executing a program.

In step S401, the image capturing apparatus sets a reference subject distance (hereinafter referred to as the “reference distance”). For example, Y1 is set as the reference distance. With respect to this reference distance, there is a method in which the image capturing apparatus sets the reference distance in advance and a method in which a distance specified via user operation is set. Next, processing proceeds to step S402.

In step S402, setting processing of a reference speed is performed. The reference speed is a camera speed that is set according to the reference distance, and is set by the control setting unit 214. Next, in step S403, processing for acquiring distance information of the subject is performed.

The distance information of the subject is acquired by the video signal processing unit 208 and the optical control unit 211, or by a distance measuring apparatus. Although there is no particular limitation with respect to a method of acquiring the distance information of the subject, for example, there is a method of acquiring distance information by using an image capturing element of a pupil division phase difference detection type.

In an image capturing element having a plurality of microlenses and a plurality of photoelectric conversion units corresponding to each microlens, phase difference signals can be acquired from each photoelectric conversion unit. A defocus amount is calculated from the phase difference signals.

The defocus amount is converted to a distance to the subject based on a lens formula of the image capturing optical system. A defocus map showing distribution of the defocus amount, and a distance image having distance information as pixel values and the like represent distribution of depth information in a depth direction with respect to a subject within a captured image.

By using these, it is possible to calculate distance information corresponding to a desired subject region. Alternatively, there is a method of acquiring distance information of the subject using a stereoscopic system configuration utilizing a plurality of image capturing units or a TOF (Time Of Flight) method. After step S403, the processing proceeds to step S404.

In step S404, the control setting unit 214 calculates an adjustment value of camera speed. In step S405, the control setting unit 214 sets a change speed of image capturing direction and performs reflection to drive speed with respect to the PT control unit 212.

Specifically, with reference to FIG. 3, with respect to the reference distance Y1 corresponding to the first subject O1, the angle θ1 is calculated based on the equation described below.

$$θ1 = {tan}^{- 1} ( X / Y 1 ) \qquad ( Equation 1 )$$

In the above equation, tan⁻¹( ) represents an inverse tangent function. A reference speed (angular velocity) can be calculated based on θ1 and a movement time of the subject from point a1 to point b1.

Processing for calculating the angle θ2 with respect to the distance Y2 to the second subject O2 is performed. The angle θ2 is calculated based on the equation described below.

$$θ 2 = {tan}^{- 1} ( X / Y 2 ) \qquad ( Equation 2 )$$

A product of θ2 and a coefficient representing a ratio of the reference distance Y1 and the distance Y2 (Y1/Y2) is calculated. An angular velocity can be calculated from θ2×(Y1/Y2) and movement time of the subject from point a2 to point b2.

Camera speed in the P direction is set based on this angular velocity, and the PT control unit 212 performs drive control in the P direction. The larger the distance Y2 is with respect to the reference distance Y1, image capturing operation is performed at a slower camera speed.

Although drive control in the P direction related to the image capturing apparatus has been explained in the example described above, drive control in the T direction can also be performed using a similar method. Therefore, a detailed explanation thereof is omitted.

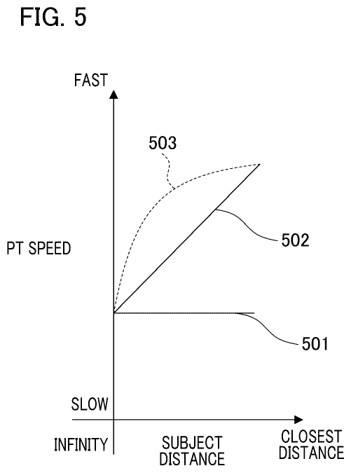

Differences between a comparative example and the present embodiment will be explained with reference to FIG. 5. The horizontal axis in FIG. 5 represents a distance from the image capturing apparatus to a subject, and the vertical axis represents PT speed. The PT speed corresponds to camera speed in the P direction or T direction, or in the P direction and T direction. A graph line 501 represents control characteristics of the comparative example, and a graph line 502 represents control characteristics of the present embodiment.

In the comparative example, as shown by the graph line 501, PT speed is constant regardless of distance to the subject, and camera speed is not changed. In contrast, in the present embodiment, as shown by the graph line 502, PT speed is changed according to distance to the subject, and PT control matching the subject is possible.

The graph line 502 represents control characteristics wherein PT speed increases and decreases linearly, and control is performed so that PT speed becomes slower as distance of the subject becomes larger. It should be noted that this example is not limited thereto, and coefficient adjustment may be performed so that PT speed changes along a curve according to a distance difference from the reference distance, as shown by a dotted graph line 503 in FIG. 5.

According to the present embodiment, more detailed subject tracking control can be realized by changing camera speed according to distance from the image capturing apparatus to the subject.

### Second Embodiment

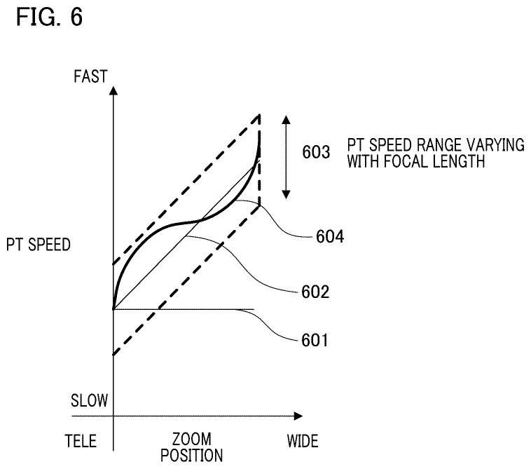

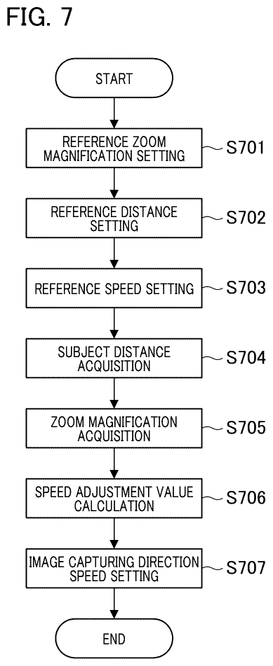

Camera control according to the present embodiment will be explained with reference to FIG. 6 and FIG. 7. Control content that further includes elements of zoom magnification in addition to the control content explained in the First Embodiment will be explained.

Differences in speed settings between a comparative example and the present embodiment will be explained with reference to FIG. 6. The horizontal axis in FIG. 6 represents a zoom position (or zoom magnification), and the vertical axis represents PT speed. A graph line 601 represents control characteristics of the comparative example, wherein a constant PT speed is set regardless of zoom position.

A graph line 602 shown in FIG. 6 represents control characteristics in a case in which PT speed is changed linearly according to zoom position (or zoom magnification). The PT speed becomes slower as the zoom position is on the telephoto side (zoom magnification is larger).

Furthermore, when taking into account an element of subject distance, as shown by a range 603 within the dotted frame, PT speed that is set becomes changeable with higher degrees of freedom. A wavy graph curve 604 shown in the range 603 exemplifies control characteristics of the present embodiment.

Even if the zoom position or zoom magnification is the same, PT speed is changed according to whether a distance from the image capturing apparatus to the subject is far or near. Therefore, for example, in a case in which a subject that is an image capturing target has been changed by changing the zoom position, it becomes possible to respond by changing camera speed according to focal length of the image capturing optical system as shown by the graph curve 604.

Processing according to the present embodiment will be explained with reference to FIG. 7. The image capturing apparatus performs setting processing of a drive control amount in the P direction according to zoom magnification and distance of the subject. Main differences from the First Embodiment will be explained.

In step S701, the image capturing apparatus sets a zoom magnification that serves as a reference (hereinafter referred to as “reference zoom magnification”). Next, in step S702, setting processing of a reference distance is performed similarly to the First Embodiment. Next, the processing proceeds to step S703.

In step S703, setting processing of a reference speed is performed. The control setting unit 214 sets a reference speed with respect to the reference zoom magnification of step S701 and the reference distance from step S702. Next, in step S704, processing to acquire a distance from the image capturing apparatus to the subject is executed, and in step S705, processing to acquire zoom magnification is executed. Next, the processing proceeds to step S706.

In step S706, the control setting unit 214 calculates an adjustment value of camera speed. Based on the distance of the subject acquired in step S704 and the zoom magnification acquired in step S705, a difference with respect to reference control characteristics (refer to graph line 602 in FIG. 6) is calculated, and processing to calculate a speed adjustment value corresponding to control characteristics taking into account the difference is performed.

The reference zoom magnification is denoted as α, and the set zoom magnification is denoted as β. Whereas in the First Embodiment, angular velocity is calculated based on θ2×(Y1/Y2) and movement time of the subject, in the present embodiment, camera speed is determined by calculating angular velocity based on the following equation that further multiplies a magnification ratio (α/β) and movement time of the subject.

$$θ 2 \times ( Y 1 / Y 2 ) \times ( α / β ) \qquad ( Equation 3 )$$

In step S707, the control setting unit 214 sets the calculated camera speed and performs reflection of the calculated camera speed to drive speed with respect to the PT control unit 212.

According to the present embodiment, by changing camera speed based on distance information of the subject and zoom magnification, control of camera operations more suitable for image capturing conditions of the subject is possible as shown in FIG. 6.

### Third Embodiment

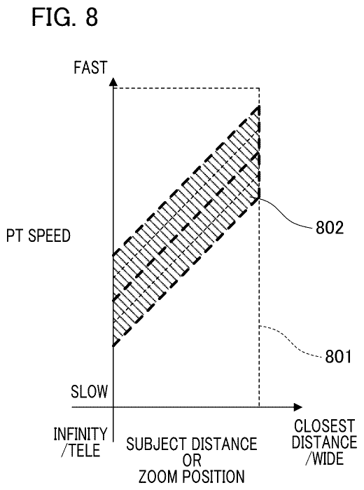

Control according to the present embodiment will be explained with reference to FIGS. 8 to 12. In the present embodiment, an explanation is provided with respect to processing to restrict a setting range of camera speed in addition to setting processing of camera speed.

With respect to camera speed, normally, image capturing operations are performed at a speed specified by user operation. For example, in a camera controller that performs remote operation, camera operations are performed by the user finely adjusting speed by the degree of tilting of an operation unit of a joystick.

In this case, in image capturing at high zoom magnification (narrow angle of view), frame-out of a subject that is an image capturing target may occur even due to minute changes in camera operation.

Differences between a comparative example and the present embodiment will be explained with reference to FIG. 8. The horizontal axis in FIG. 8 represents a distance from the image capturing apparatus to the subject or zoom position, and the vertical axis represents PT speed. Because the comparative example has no restriction on setting speed and PT speed can be arbitrarily selected within a range 801 within the dotted frame, there is a possibility of excessive settings.

In contrast, in the present embodiment, it becomes possible to suppress excessive settings by restricting a camera speed range using at least one of distance of the subject or zoom position. By this restriction, rather, operability is improved.

A parallelogram-shaped range 802 shown by hatching in FIG. 8 represents a speed control range according to the present embodiment, and a PT speed range that is restricted corresponding to either one of distance of the subject or zoom position is set. In the illustrated example, although restrictions are provided for both upper and lower limits with respect to reference characteristics, restrictions may be provided for only the upper limit or lower limit.

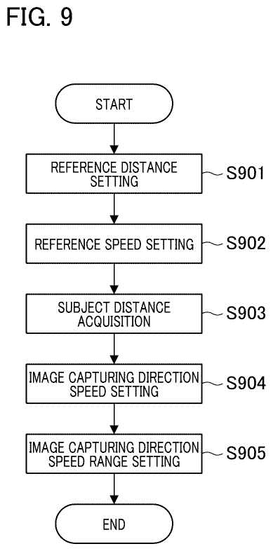

FIG. 9 is a flowchart explaining processing in a case in which restrictions are placed on PT speed according to distance of the subject. Basically, processing of step S901 to step S904 is executed similarly to PT speed setting shown in the First Embodiment.

In step S901, a reference distance (Y1) is set, and in step S902, a reference speed with respect to the reference distance is set. In step S903, a distance (Y2) of the subject is acquired, and in step S904, processing to calculate PT speed is executed by calculating a ratio (Y1/Y2) of the reference distance and the distance of the subject.

In step S905, setting processing of a speed range is executed based on the PT speed calculated in step S904. The control setting unit 214 restricts the speed range based on distance of the subject. Methods described below exist as methods of setting the restricted speed range.

(A) A method of determining a permissible speed range by setting an upper limit (maximum speed) or lower limit (minimum speed) using a width of a predetermined ratio, such as plus or minus 10%, with respect to the calculated PT speed. (B) A method of changing a width of the speed range according to magnitude of PT speed with respect to the calculated PT speed.

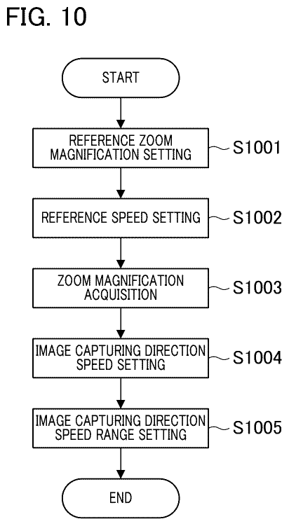

Next, a case in which a restriction is placed on speed range according to focal length or zoom magnification of the image capturing optical system will be explained. FIG. 10 is a flowchart explaining processing in the image capturing system. In step S1001, a reference zoom magnification (α) that serves as a reference is set, and in step S1002, a reference speed with respect to the reference zoom magnification is set.

In step S1003, processing to acquire a zoom magnification (β) is performed, and in step S1004, processing to calculate PT speed based on a ratio (α/β) of the reference zoom magnification and the acquired zoom magnification is executed.

In step S1005, the control setting unit 214 executes setting processing of a speed range based on the PT speed calculated in step S1004. The control setting unit 214 restricts the speed range based on zoom magnification. Methods of setting the restricted speed range are similar to (A) and (B) described above.

As described above, there is an advantage that operation of the image capturing system becomes easier by setting a speed range that is restricted by distance information of the subject or zoom magnification.

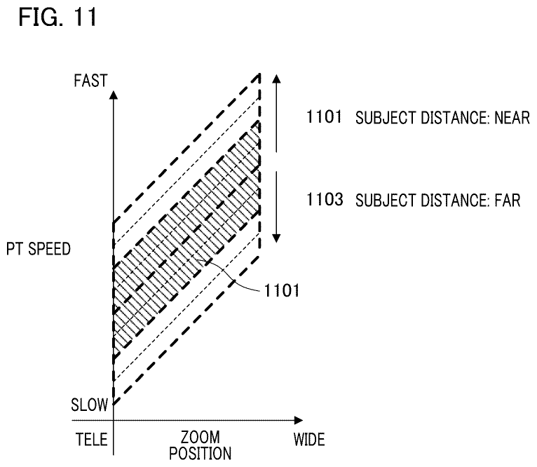

Next, an explanation is provided with respect to setting of a speed range in a case in which distance of the subject and focal length or zoom magnification are taken into account. The horizontal axis in FIG. 11 represents zoom position (or zoom magnification) and the vertical axis represents PT speed.

A reference range 1101 shown by hatching represents a PT speed range set according to zoom position. Furthermore, by taking into account distance of the subject, processing to shift the reference range 1101 in the vertical axis direction is performed.

For example, in a case of a subject at a close distance than a predetermined near distance, the speed range (setting range) is changed to shift toward a side at which PT speed becomes larger. In addition, in a case of a subject at a far distance than a predetermined far distance, the speed range (setting range) is changed to shift toward a side at which PT speed becomes smaller.

In this case, there is a method of changing the entire speed range by shifting and a method of changing only the speed range on one side of either the upper limit (maximum speed) or lower limit (minimum speed).

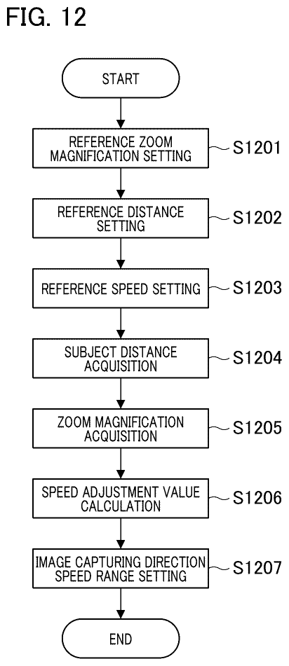

FIG. 12 is a flowchart explaining processing in a case in which restrictions are provided for PT speed by distance of the subject and zoom magnification. An explanation is provided mainly with respect to portions that differ from processing of the examples described above. In step S1201, a reference zoom magnification is set, in step S1202, a reference distance is set, and in step S1203, a reference speed is set.

Next, in step S1204, subject distance is acquired, and in step S1205, zoom magnification is acquired. In step S1206, the control setting unit 214 sets PT speed by calculating a speed adjustment value with respect to the reference speed.

In step S1207, the control setting unit 214 determines a speed range (setting range) based on the calculated PT speed. At this time, the speed range is changed according to the distance of the subject acquired in step S1204. An allowable range of final camera speed is determined by shift processing corresponding to distance of the subject (refer to FIG. 11) with respect to a reference range based on the calculated PT speed.

By restricting the speed range based on distance information of the subject and zoom magnification in this manner, it becomes possible to perform more detailed control. For example, in image capturing at high zoom magnification, frame-out of a tracking subject that may occur due to minute changes in camera operation can be suppressed.

### Fourth Embodiment

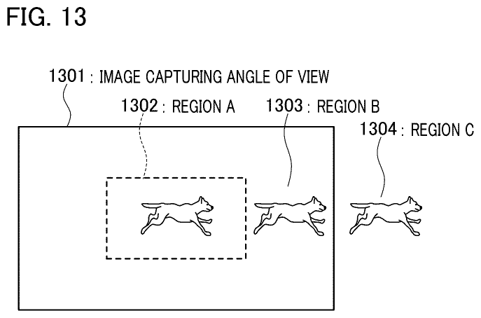

The present embodiment will be explained with reference to FIGS. 13 to 15. In the present embodiment, an explanation is provided with respect to speed change processing according to position of a subject. FIG. 13 is a diagram showing changes in position of a moving subject with respect to an image capturing angle of view 1301.

A moving subject moves from a left direction to a right direction. A region A is a region 1302 when the moving subject is in a vicinity of a center of the image capturing angle of view 1301. A region B is a region 1303 when the moving subject is in a vicinity of a periphery of the image capturing angle of view 1301. A region Cis a region 1304 when the moving subject becomes outside the image capturing angle of view.

In FIG. 13, because a moving subject that is in region A is captured in the center of the image capturing angle of view 1301, camera operation as camera work is hardly necessary. In a case in which a moving subject is in region B, the position is a position that deviates from the center of the image capturing angle of view 1301.

Therefore, in order to capture the moving subject in the center of the image capturing angle of view, by performing larger camera work compared to region A, it is possible to quickly align with the center of the image capturing angle of view. In a case in which a moving subject is in region C, the moving subject is outside the image capturing angle of view. Therefore, compared to region B, it is necessary to recapture the moving subject within the image capturing angle of view quickly by performing even larger camera work.

With respect to a detection method of a subject, known methods may be used. For example, in a case of a subject within the image capturing angle of view, recognition is possible using a detection method by image analysis. In contrast, in a case of a subject outside the image capturing angle of view, methods described below exist using a distance measuring apparatus.
LIDAR (Light Detection And Ranging): A distance measuring method using laser light and the like.
A distance measuring method using a wireless terminal apparatus such as UWB (Ultra-Wide Band).

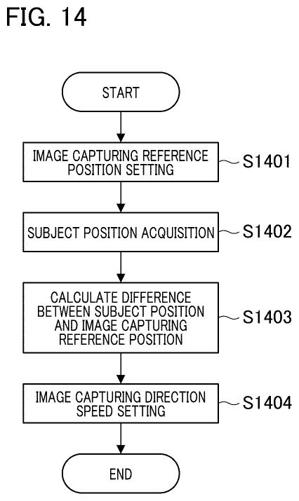

Processing according to the present embodiment will be explained with reference to FIG. 14. In step S1401, the image capturing apparatus sets an image capturing reference position. In the example of FIG. 13, a center position of the image capturing angle of view 1301 is set as the image capturing reference position.

The image capturing reference position is set according to user operation instructions or is automatically set by the image capturing apparatus. Next, in step S1402, the image capturing apparatus acquires subject position, and in step S1403, the image capturing apparatus calculates a degree of deviation from the image capturing reference position.

For example, the degree of deviation is calculated as a difference between the image capturing reference position and the subject position in the P direction. In the example of FIG. 13, the degree of deviation is zero in region A. As the subject moves, the degree of deviation becomes larger in region B, and the degree of deviation becomes even larger in region C.

Next, in step S1404, the image capturing apparatus performs image capturing direction speed setting according to the degree of deviation. When determining PT speed by calculating a speed adjustment value, the control setting unit 214 performs speed adjustment by multiplying PT speed by a ratio corresponding to the degree of deviation.

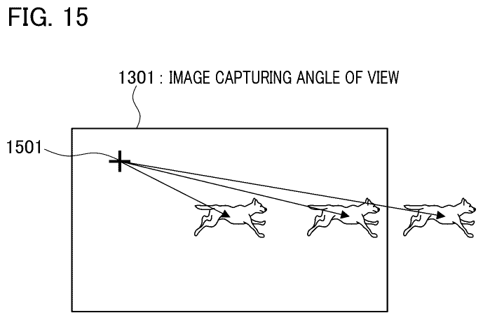

With respect to the image capturing reference position set in step S1401, setting is possible at an arbitrary position without being limited to a center position of the image capturing angle of view. FIG. 15 shows an image capturing reference position 1501 that is displaced from the center position of the image capturing angle of view.

In this case, even if a moving subject is at the center position of the image capturing angle of view, a degree of deviation from the image capturing reference position 1501 is calculated. Because the degree of deviation becomes larger as subject position becomes farther from the image capturing reference position 1501, by multiplying PT speed by a ratio corresponding to the degree of deviation, speed adjustment is performed further compared to the example of FIG. 13.

### Fifth Embodiment

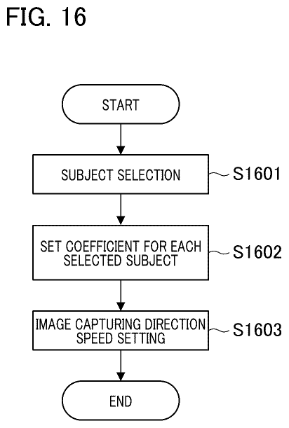

The present embodiment will be explained with reference to FIG. 16. In the present embodiment, an explanation is provided with respect to processing according to type of subject and image capturing scene. The table described below shows an example of speed level settings corresponding to type of subject and image capturing scenes.

TABLE 1

| | Speed Level |
|---|---|
| Subject Type | |
| Normal | 3 |
| Person | 4 |
| Animal | 5 |
| Vehicle | 10 |
| Image Capturing Scene | |
| Normal | 3 |
| Sports | 7 |
| Landscape | 2 |

With respect to types of subject, speed levels become higher for subjects having high mobility. In addition, with respect to image capturing scenes, speed levels become higher in scenes for capturing moving subjects in sports and the like. “Normal” in the table corresponds to default settings, and a speed level that serves as a reference is set. With respect to speed levels at normal time, speed levels are changed for each subject or for each image capturing scene.

With respect to settings of subjects and image capturing scenes, the methods described below exist:
a method in which settings are performed by a user selecting a type of subject and an image capturing scene by primarily assuming image capturing environment.
a method in which the image capturing apparatus automatically sets speed levels each time a subject that is an image capturing target changes by using existing subject recognition technology.

Although the speed levels shown in Table 1 are used for camera speed adjustment, these levels may be used for speed range adjustment.

Processing according to the present embodiment will be explained with reference to FIG. 16. In step S1601, selection processing of a subject that is an image capturing target or an image capturing scene is performed. The image capturing apparatus selects a subject or an image capturing scene according to user operation instructions, or performs processing based on automatic recognition results to select a subject.

In step S1602, the image capturing apparatus sets a speed level according to the selected subject or image capturing scene. A basic camera speed is, for example, camera speed corresponding to a speed level at normal time.

The control setting unit 214 sets a coefficient corresponding to the speed level with respect to the subject or image capturing scene selected in step S1601. In step S1603, the control setting unit 214 sets camera speed taking into account the coefficient with respect to a reference speed.

According to the present embodiment, more detailed camera work can be realized by performing settings or changes of camera speed according to type of subject and image capturing scene.

### Sixth Embodiment

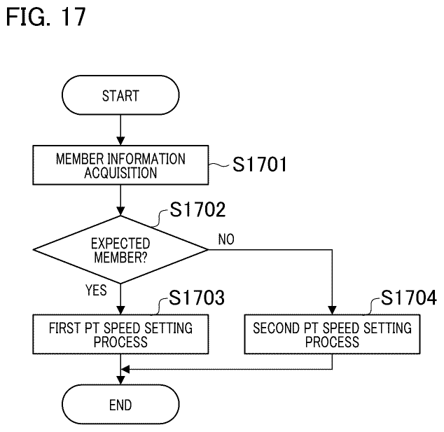

The present embodiment will be explained with reference to FIG. 17. In the present embodiment, an explanation is provided with respect to processing corresponding to optical members (lenses, conversion mounts, converters, and the like) and drive apparatuses. Configuration of the image capturing system varies, and for example, may be configured by combinations of a plurality of elements described below.
A configuration provided with a lens unit, a camera main body unit, and a drive apparatus (a pan-tilt head and the like).
A configuration of a lens exchange system wherein a lens unit is detachable from a camera main body unit.
A configuration wherein a drive apparatus is separately connectable with respect to a camera main body unit.

For example, the drive apparatus is an electric pan-tilt head used for posture control of the camera, an electric zoom apparatus used for angle of view control, and the like.

In a case in which the image capturing system is configured by a plurality of members, differences arise in various aspects with respect to size, weight, center of gravity, drive torque, and the like of each member. In each state wherein differences exist in the image capturing system, effects on the image capturing system may arise in a case in which camera speed is uniformly set.

For example, there is a possibility that changes in image capturing direction become impossible due to step-out of a motor for PT driving. In addition, in a case in which high-speed driving is performed when a center of gravity position of the entire image capturing apparatus changes, there is a possibility that a position of the image capturing apparatus becomes unstable.

Therefore, according to the present embodiment, adjustment of operations according to members that are connected to the image capturing apparatus is performed, and measures for avoiding situations leading to malfunctions to the greatest extent possible are implemented.

Processing according to the present embodiment will be explained with reference to FIG. 17. In step S1701, the image capturing apparatus acquires member information. The member information is information representing what members are attached as constituent elements of the image capturing system.

There is a method of acquiring member information via user operation and a method in which the image capturing apparatus automatically detects members and acquires member information thereof. For example, the control setting unit 214 or an information acquisition unit performs processing to acquire member information at startup of the image capturing system. Next, the processing proceeds to step S1702.

In step S1702, the image capturing apparatus determines whether or not target members are members assumed in advance by using the acquired member information. The control setting unit 214 determines combinations of attached members. In a case in which it is determined that the combination is a combination assumed in advance, such as a known combination of genuine members, processing proceeds to step S1703. In addition, in a case in which it is determined that the combination is not a combination assumed in advance, processing proceeds to step S1704.

In step S1703, the control setting unit 214 performs PT speed setting corresponding to torque amount and the like according to combinations assumed in advance. In addition, in step S1704, the control setting unit 214 performs PT speed setting for handling unexpected movements.

For example, in a case in which a drive unit is a motor, PT speed is set so that motor drive control is performed at low speed and high torque. Alternatively, PT speed is set so that safer operation is guaranteed by stopping the drive unit. The processing of step S1704 is executed based on determination results for each member having combinations determined to be unexpected.

According to the present embodiment, more suitable control of camera speed is possible even in a case in which members configuring the image capturing system are changed.

### Modification Example

In the embodiments described above, an example was shown in which adjustment of camera speed (maximum speed and the like) was performed in a constant speed state. In contrast, in a modification example, adjustment of camera speed is performed in an acceleration state or deceleration state of the drive unit.

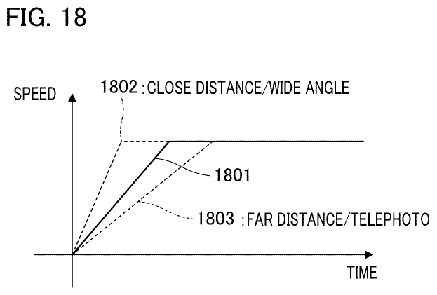

FIG. 18 is a diagram explaining speed control from acceleration to constant speed. The horizontal axis is a time axis, and the vertical axis represents camera speed (PT speed and the like). A graph line 1801 represents reference acceleration characteristics, and transitions to constant speed after speed increases at a predetermined acceleration.

A graph line 1802 represents acceleration characteristics in a case of a subject at a close distance or wide-angle image capturing. The graph line 1802 transitions to constant speed after speed increases in a shorter time (acceleration period is short) compared to graph line 1801. A graph line 1803 represents acceleration characteristics in a case of a subject at a far distance or telephoto image capturing.

The graph line 1803 transitions to constant speed after speed increases over a longer time (acceleration period is long) compared to graph line 1801. It should be noted that speed control in a deceleration state is similar, and transitions to a stopped state after speed decreases over a deceleration period that is determined according to distance of the subject or focal length or zoom magnification.

In addition, in the modification example, control characteristics in an acceleration state or a deceleration state are changed according to position or type of subject with respect to image capturing angle of view, image capturing scene, members configuring the image capturing system, and the like. Accordingly, more suitable control of camera speed is possible.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the subject tracking apparatus and the like through a network or various storage media. Then, a computer (or a CPU, an MPU, or the like) of the subject tracking apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-076073, filed on May 8, 2024, which is hereby incorporated by reference herein in its entirety.

What is claimed is:

1. A subject tracking apparatus configured to perform tracking by performing image capturing of a subject using an image capturing unit, comprising at least one processor or circuit configured to function as:
an acquisition unit configured to acquire distance information of the subject; and
a control unit configured to change an image capturing direction or an image capturing range and a speed of control by controlling the image capturing unit,
wherein the control unit is configured to set or change speed of the control corresponding to the acquired distance information.

2. The subject tracking apparatus according to claim 1, wherein the acquisition unit is configured to acquire the distance information from the image capturing unit or a distance measuring unit, and
the control unit is configured to determine speed of the control to be a first speed in a case in which a distance to the subject is a first distance, and to determine speed of the control to be a second speed smaller than the first speed in a case in which the distance to the subject is a second distance greater than the first distance.

3. The subject tracking apparatus according to claim 1, wherein the control unit is configured to determine speed of the control or the speed range by using one or more pieces of information among the distance information and zoom magnification of the image capturing unit.

4. The subject tracking apparatus according to claim 1, wherein the control unit is configured to limit speed range of the control according to the distance information or zoom magnification of the image capturing unit.

5. The subject tracking apparatus according to claim 1,
wherein the at least one processor or circuit is configured to function as a setting unit configured to set an image capturing reference position of the image capturing unit, and
wherein the at least one processor or circuit is configured such that the control unit calculates a difference between a position of the subject and the set image capturing reference position and changes speed of the control.

6. The subject tracking apparatus according to claim 5, wherein the control unit is configured to perform speed adjustment by multiplying speed of the control by a ratio corresponding to the difference.

7. The subject tracking apparatus according to claim 6, wherein the image capturing reference position is a center position of an image capturing angle of view, and
wherein the control unit is configured to set a larger speed of the control in a case in which the subject is outside the image capturing angle of view compared to in a case in which the subject is within the image capturing angle of view.

8. The subject tracking apparatus according to claim 6, wherein the image capturing reference position is a position different from a center position of an image capturing angle of view, and
wherein the control unit is configured to set a larger speed of the control as a position of the subject becomes farther from the image capturing reference position.

9. The subject tracking apparatus according to claim 6, wherein the control unit is configured to change the speed or speed range of the control according to type of the subject or image capturing scene.

10. The subject tracking apparatus according to claim 9, wherein the control unit is configured to change speed of the control by using a coefficient corresponding to type of the subject or image capturing scene.

11. An image capturing system comprising a subject tracking apparatus configured to perform tracking by performing image capturing of a subject using an image capturing unit, the image capturing system comprising at least one processor or circuit configured to function as:
an acquisition unit configured to acquire distance information of the subject;
a drive unit configured to drive the image capturing unit,
a control unit configured to change image capturing direction or image capturing range and a speed of the control by controlling the image capturing unit, and
wherein the control unit is configured to set or change speed of the control corresponding to the acquired distance information.

12. The image capturing system according to claim 11, wherein
the control unit is configured to acquire member information representing members configuring the image capturing system, and set or change speed of the control according to the member information.

13. The image capturing system according to claim 12, wherein the control unit is configured to determine whether or not the member is an assumed member by using the member information, and perform control so as to make speed of control of the drive unit smaller in a case in which it is determined that the member is not an assumed member compared to in a case in which it is determined that the member is an assumed member.

14. The image capturing system according to claim 12, wherein the control unit is configured to adjust speed of the control in an acceleration state or deceleration state of the drive unit.

15. The image capturing system according to claim 14, wherein the control unit is configured to perform control of acceleration or deceleration over a first period in a case in which a distance to the subject is a first distance, and perform control of acceleration or deceleration over a second period longer than the first period in a case in which the distance to the subject is a second distance greater than the first distance.

16. The image capturing system according to claim 12, wherein members configuring the image capturing system are optical members or a drive apparatus used in posture control of the image capturing unit.

17. The image capturing system according to claim 11, wherein the control unit is configured to perform setting or changing of one or more among speed of posture control of the image capturing unit, speed of control of lens operation that changes an image capturing angle of view, and control speed related to trimming processing of images within the image capturing angle of view.

18. A control method executed in a subject tracking apparatus configured to perform tracking by performing image capturing of a subject using an image capturing unit, the control method comprising:
acquiring distance information of the subject; and
changing an image capturing direction or an image capturing range and speed of control by controlling the image capturing means,
wherein processing is performed to set or change speed of the control corresponding to the acquired distance information.

19. A non-transitory computer-readable storage medium storing a computer program including instructions for executing the following processes:
wherein the processes are executed in a subject tracking apparatus configured to perform tracking by performing image capturing of a subject using an image capturing unit, and wherein the processes comprising:
acquiring distance information of the subject; and
changing an image capturing direction or an image capturing range and speed of control by controlling the image capturing unit,
wherein processing is performed to set or change speed of the control corresponding to the acquired distance information.
